(19) United States
(12) Patent Application Publication
(10) Pub. No.: US 2005/0086154 A1
(43) Pub. Date: Apr. 21, 2005

(54) Method of conducting foreign exchange transactions for a finite plurality of entities

(76) Inventor: Marretta Marie Mistretta, Livonia, MI (US)

Correspondence Address: DYKEMA GOSSETT PLLC, 39577 WOODWARD AVENUE, SUITE 300, BLOOMFIELD HILLS, MI, 48304, US

(21) Appl. No.: 10/967,853

(22) Filed: Oct. 18, 2004

Related U.S. Application Data
(63) Continuation of application No. 09/543,063, filed on Apr. 5, 2000.

(51) Int. Cl. G06F 17/60

(52) U.S. Cl. 705/37

(57) ABSTRACT

A method of conducting exchanges of currencies for a finite plurality of entities, at least two of which are in jurisdictions having differing currencies, the method comprising: evaluating the currency exchange requirements of a first entity having a first currency during a first predetermined time frame for buying or selling the first currency and selling or buying currencies other than the first currency; communicating the currency exchange requirements of the first entity to a central currency exchange management entity; evaluating the currency exchange requirements of at least a second entity having a second currency during the first predetermined time frame for buying or selling the second currency and selling or buying currencies other than the second currency; communicating the currency exchange requirements of the second entity to the central currency exchange management entity; obtaining a rate of exchange for buying or selling the first currency and selling or buying currencies other than the first currency; at least obtaining a rate of exchange for buying or selling the second currency and selling or buying currencies other than the second currency; determining a net amount of currency exchange transactions required to buy or sell the first currency to sell or buy currencies other than the first currency; at least determining a net amount of currency exchange transactions required to buy or sell the second currency and to buy or sell the first currency and the other currencies; and executing the net currency exchanges by having the central currency exchange management entity execute with an entity separate from the plurality to conduct the currency exchanges for the first predetermined time frame to decrease currency exposures on the first predetermined time frame of the first entity and at least the second entity.

### FIELD OF THE INVENTION

The field of the present invention relates to foreign currency exchange transactions to minimize foreign currency exchange exposures. More particularly, the field of the present invention is that of foreign currency exchange transactions for multiple entities in foreign jurisdictions having differing currencies.

### BACKGROUND OF THE INVENTION

During the last two decades of the 20th Century, the supremacy of market-oriented economies has been clearly shown. Countries that are least restrictive in the foreign exchange of goods, services and capital tend to have higher rates of prosperity. Accordingly, more countries now host manufacturing, or service facilities of corporate entities that have a headquarters or corporate parent in another country. For example, the United States, Canada, Mexico and South America have greatly benefited from the influx of capital from business entities headquartered in Asia and Western Europe. Additionally, many former Eastern European or Soviet Block countries have opened up their borders to an influx of foreign capital from Western Europe and North American sources of investment. The resultant globalization of the world economy has caused many large corporate entities to open facilities around the world.

Most manufacturing entities, regardless of their headquarters' nationality, pay their payroll to their local (location of manufacturing facility) employees in the local currency. However, many suppliers of a given manufacturing facility require payment in their own local currency and it is not uncommon for major suppliers to reside in a country foreign to that of the manufacturing facility or of the corporate headquarters. To further add complexity to a typical business situation, often the major revenue-generating source from a product produced in a given manufacturing facility is in the market of still another country. Whenever a geopolitical separation between the source of the revenue of a business entity and its source of working capital and/or expenses exists, there is typically a need for a currency exchange.

After World War II, the currency exchange rates between many larger industrialized nations were fixed under the Bretton Woods Agreement. However, beginning in the late 1960s and early 1970s, currency relationships between most countries were set in a floating manner. The float between the various currencies can often change in an unpredictable manner. Accordingly, many international companies have concluded that it is prudent to hedge against all or at least a significant portion of such possible currency fluctuations. Therefore, to meet future economic obligations, many corporations go to the foreign exchange market to fix the rate at which they will buy the needed foreign currency in relationship to the amount at which they will sell their own or another currency.

The above noted foreign currency exchange transaction problems are magnified when dealing with a large North American headquartered corporation which has extensive operations in many foreign countries. For instance, the North American corporation may have a German division that has to pay a Czech supplier in Czech Korunas. The same corporation may have a Czech division with a German supplier who requires payment in Euros. Since the divisions typically operate independent from one another it is often common for both divisions to be unaware of the other's need for foreign currency exchange. Accordingly, each division separately will attempt to make the foreign currency transactions. When making a foreign currency transaction regardless of the counter bearing party, there is an economic cost, called the spread, which is typically expressed in pips, meaning 1/100th of a percentage point. For example, the Euro is currently at near parity with the U.S. dollar. If the U.S. dollar and Euro were quoted at absolute parity, to sell dollars to buy Euros, a seller would receive approximately 0.9995 Euro for every dollar. The bid price for buying Euros and selling dollars would be 1.005 Euros to buy one dollar. Accordingly the spread for the exchange would be 10 pips.

The rate quoted for the currency transaction is partially dependent upon the creditworthiness of the party requesting the transaction. This is because the counter-bearing party (typically a bank) must bear the credit risk of one of the parties involved in the transaction, should it default or file bankruptcy before the currency transaction is formally completed, typically on a spot market of least two business days. Accordingly, an entity with a greater creditworthiness can often achieve a currency exchange transaction with a lower spread cost. Relatively large currency exchange transactions usually bring about a better rate due to the lower administrative costs per unit of currency exchange. The exchanging of currency on the international market requires a trading skill which often takes time and experience to develop to its maximum capabilities. Often a single manufacturing facility or division of a large manufacturing concern will not have the financial staff with the trading experience required to minimize the cost to the local operation in its foreign currency exchange transactions.

It is desirable to provide a method of conducting exchanges of currencies wherein as large an entity as possible conducts the currency transactions to increase the creditworthiness of the party conducting the trade, and thereby possibly lowering the spread. It is desirable to provide a method of conducting exchanges of currency for a finite plurality of entities wherein at least two of the entities are in jurisdictions having differing currencies wherein a central currency exchange management entity with highly competent traders is conducting the required currency exchange transactions. It is also desirable to provide a method of conducting exchanges of currencies for a finite plurality of entities wherein at least two of the entities are in jurisdictions having differing currencies wherein the currency transactions can be for the largest monetary amount possible to take advantage of any volume discount in the spread. It is sill further desirable to provide a method of conducting exchanges of currencies for a finite plurality of entities, at least two of the entities being in jurisdictions having differing currencies wherein the total number of currency exchange transactions can be minimized.

### SUMMARY OF THE INVENTION

To make manifest the above-delineated desires, the revelation of the present invention is brought forth. In a preferred embodiment the present invention brings forth a method of conducting exchanges of currency for a plurality of entities wherein at least a first and second of the entities are in jurisdictions having different currencies. The method includes the steps of evaluating the currency exchange requirements of a first entity having a first currency on a first determined time frame for selling the first currency and buying a second currency of the second entity. The currency exchange requirements of the first entity are communicated to a central currency exchange management entity. The currency exchange requirements of the second entity during the first predetermined time frame are made for buying the first currency and selling the second currency of the second entity. A quote is obtained for a rate of exchange for selling and buying the second currency and buying and selling the first currency. A determination is made of the net amount of currency exchange transactions that are required to buy or sell the first currency and to sell or buy the second currency. The central currency exchange management entity then executes a net currency exchange transaction to conduct the net currency exchanges with an outside entity to limit the exposure of currency transactions of the first and second entities. If desired, the spread between the quotes for buying and selling of the currencies can be credited to the account of the central currency exchange management entity.

The method of the present invention provides an advantage in that it lowers the absolute amount of currency transactions which must be conducted by netting currency transactions with one another. The method of the present invention is also advantageous in that it combines the required currency transactions to minimize the total amount of currency transactions that are required. The method of the present invention is further advantageous in that it maximizes the size of the currency transaction and thereby can often lead to lower spread costs. The method of the present invention is further advantageous in that it allows currency transactions to be conducted by more experienced, professional traders.

It is the desire of the present invention to provide a method of conducting exchanges of currencies for a finite plurality of entities where at least two of the entities are in jurisdictions having differing currencies wherein the method lowers the amount of currency exchange transactions which are required.

It is another desire of the present invention to provide a method of conducting exchanges of currency for a finite plurality of entities wherein at least two of the entities are in jurisdictions having differing currencies wherein more professional management can conduct such currency exchange transactions. It is still another desire of the present invention to provide a method of obtaining exchanges of currencies for a finite plurality of entities wherein at least two of the entities are in jurisdictions having differing currencies wherein the aggregate amount of currency being transferred has a lower spread due to the greater amount of currency being exchanged in a single transaction and also benefiting from a diminished security risk of a larger business entity rather than separately controlled or smaller entities.

The above noted and other features and advantages of this invention will become apparent to those skilled in the art from the following detailed description and accompanying drawing illustrating features of this invention by way of example.

### BRIEF DESCRIPTION OF THE DRAWINGS

FIG. 1 is a schematic view of a preferred embodiment method of conducting exchanges of currencies for a finite plurality of entities, at least two of said entities being in jurisdictions having differing currencies.

FIG. 2 is a schematic view of an alternate preferred embodiment of the present invention having four different entities, each having its own separate currency.

### DETAILED DESCRIPTION OF THE INVENTION

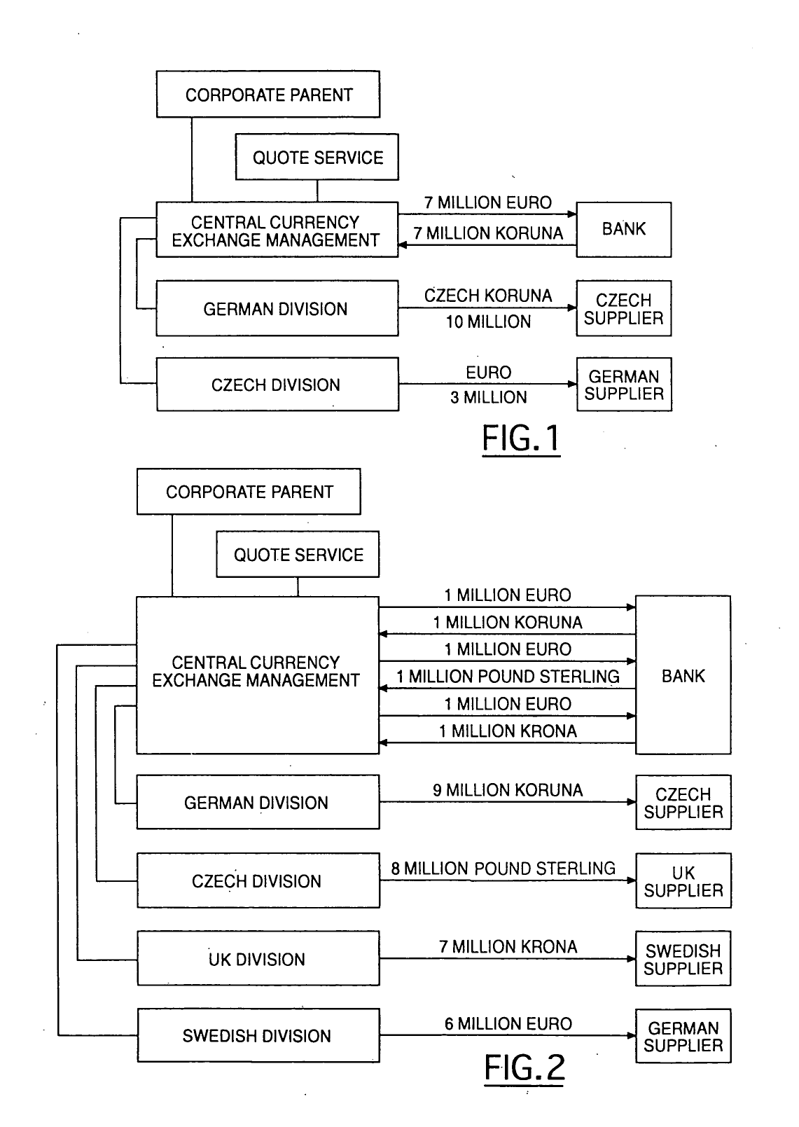

Referring to FIG. 1, a corporate parent has a central currency exchange management operation. The corporation also has a manufacturing division that is located in Germany. The German manufacturing division typically keeps its working capital in Euros. The corporate parent also has a Czech division. The Czech division operates using their local currency which is the Czech Koruna.

The German division may be a wholly owned subsidiary, a separate corporation, or a joint venture of the corporate parent, however, for purposes of description of this invention it is considered a separate entity. In like manner the Czech division is also so defined. The German division has a Czech supplier. The Czech supplier has provided engine mounts to the German division. The terms of the supply contract of the Czech supplier specify that the Czech supplier must be paid on a first predetermined time frame such as April 15 to obtain a two percent net discount. The financial terms of the payment to the Czech supplier require payment in the Czech Koruna. (For purposes of illustration all amounts of currencies are listed in millions of U.S. Dollars for discussion of the invention; however, those skilled in the art will realize that such amounts of currency may be referred to in the Czech currency or in Euros or another specified currency). The payment of the $10 million in Czech Korunas will be for a first predetermined time frame such as April 15.

The Czech division keeps its working capital in Korunas. The Czech division must make a payment on April 15 to its German supplier for shock absorbers. The amount of the payment to the German supplier is $3 million worth of Euros. The German division therefore determines that it needs to sell $10 million worth of Euros to purchase $10 million of Czech Korunas to pay their Czech supplier. The Czech division evaluates that it needs to sell $3 million worth of Korunas to purchase $3 million of Euros so that it may pay its German supplier. The currency evaluation requirements of the German division and of the Czech division are both communicated to a central currency exchange management. The central currency exchange management may be located anywhere in the world, however typical locations will be at the headquarters of the corporate parent or in an international banking center such as New York or London.

To protect against the adverse consequences that can occur due to currency fluctuations it is often desirable to hedge all or a large percentage of the payment obligations of a division. In the example shown 100% hedging is assumed, however, as will be apparent to those skilled in the art, the actual hedging decision may be dependent upon the currencies involved as well as the current and perceived evaluation of changes in local and international economic conditions.

As previously mentioned, the evaluations of the currency exchange requirements of the German division and of the Czech division are communicated to the central currency exchange management. The central currency exchange management will obtain a quoted rate for the required currency exchanges. Bid and ask prices will be asked and a spread will be determined for buying and selling the currencies. The central currency exchange management also determines the net currency exchange transactions required to buy or sell the currencies of the. German and the Czech divisions. The net currency transactions required by the German and Czech divisions is for selling $7 million Euros and buying $7 million Korunas. This transaction will occur with an outside broker or bank. The method of the present invention brings forth several advantages. The first advantage is that by having a central currency exchange management the corporate parent is in greater control of currency transactions and losses because unauthorized currency speculations are easier to avoid. The next advantage is that instead of having two smaller transactions by the German and Czech divisions the central currency exchange management can make one trade. If desired, the spread which is determined by a bid and ask price received from a quote service on the portions of the currency transactions which are netted out, can be credited to the account of the central currency exchange management. A further advantage is that the larger size of trade and the enhanced credit condition of the corporate parent can be utilized in many occasions to lower the spread required for the trades to occur.

FIG. 1 only shows the net amount of currency transactions needed for each division due to a payment to a single supplier. However, those skilled in the art will realize that to find the actual net currency trades required by each division one will also have to take into account currency trades required by influxes of capital from revenue. For instance, the Czech division may sell $6 million worth of goods into France and accordingly receive a payment in $6 million Euros which must be converted to Korunas for its working capital. Accordingly, in determining the net currency trades required, influxes of capital as well as payments of capital are evaluated. Also, especially when considering the Euro, currency transactions from sources of revenue or to suppliers in various different European Euroland countries must also be considered in determining the net currency amount of currency exchange transactions required by a given entity.

Referring to FIG. 2, a somewhat more complex transaction conducted under the method of the present invention is schematically shown. In FIG. 2 there is a German division, a Czech division, a U.K. division, and a Swedish division. The corporate parent is again a North American concern. The German division requires a payment of $9 million worth of Korunas to a Czech supplier. The Czech division requires a payment of $8 million Pounds Sterling to a U.K. supplier. The U.K. division requires a payment of $7 million Korna to a Swedish supplier. The Swedish division requires a $6 million payment of Euros to a German supplier. As with the case in FIG. 1, all required payments are to be made on April 15. To hedge the payments and to limit the currency exposure, the method of the present invention is practiced. The net currency trades required by the entities are as follows: There is a requirement to buy $9 million worth of Czech Korunas; $8 million of Pounds Sterling; $7 million of Swedish Korna and $6 million of Euros. There is a requirement to sell $9 million of Euros, $8 million of Czech Korunas, $7 million of Pounds Sterling and $6 million of Swedish Kornas. When determining the net amount of currency exchange transactions required there is a first currency exchange transaction of $1 million Euro to receive $1 million Czech Korunas. There is a second transaction of $1 million Euros to receive $1 million Pounds Sterling. There is a third currency transaction to sell $1 million Euros to receive $1 million Swedish Kornas. Instead of the previously required four trades by each division, the central currency exchange management may satisfy the currency exchange hedging requirements by executing just three separate trades.

The present inventive method of conducting exchanges of currency has been shown in preferred embodiments. However, it will be apparent to those skilled in the art that various modifications can be made without departing from the spirit or scope of the present invention as it is encompassed in the specifications and drawings and by the following claims.

1. A method of conducting exchanges of currencies for a finite plurality of entities, at least two of said entities being in jurisdictions having differing currencies, said method comprising:
evaluating the currency exchange requirements of a first entity having a first currency during a first predetermined time frame for buying or selling said first currency and selling or buying currencies other than said first currency;
communicating said currency exchange requirements of said first entity to a central currency exchange management entity;
evaluating the currency exchange requirements of at least a second entity having a second currency during said first predetermined time frame for buying or selling said second currency and selling or buying currencies other than said second currency;
communicating said currency exchange requirements of said second entity to said central currency exchange management entity;
obtaining a rate of exchange for buying or selling said first currency and selling or buying currencies other than said first currency;
at least obtaining a rate of exchange for buying or selling said second currency and selling or buying currencies other than said second currency;
determining a net amount of currency exchange transactions required to buy or sell said first currency to sell or buy currencies other than said first currency;
at least determining a net amount of currency exchange transactions required to buy or sell said second currency and to buy or sell said first currency and said other currencies; and
executing said net currency exchanges by having said central currency exchange management entity execute with an entity separate from said plurality to conduct said currency exchanges for said first predetermined time frame to decrease currency exposures on said first predetermined time frame of said first entity and at least said second entity.

2. A method of conducting exchanges of currencies for a finite plurality of entities as described in claim 1 wherein said quote is obtained from a published price.

3. A method of conducting exchanges of currencies for a finite plurality of entities as described in claim 2 wherein said quote is an ask price of a bid ask quotation.

4. A method of conducting exchanges of currency for a finite plurality of entities as described in claim 2 wherein said quote is a bid price of a bid ask quotation.

5. A method of conducting exchanges of currencies for a plurality of entities, at least first and second said entities being in jurisdictions having differing currencies, said method comprising:
evaluating the currency exchange requirements for a first entity having a first currency on a first predetermined time frame for selling or buying said first currency and, buying or selling a second currency of said second entity;
communicating said currency exchange requirements of said first entity to a central currency exchange management entity;
evaluating the currency exchange requirements of said second entity on said first predetermined time frame for selling or buying said second currency and buying or selling a second currency of said second entity;
obtaining a quote of a rate of exchange for selling or buying said first currency and buying or selling said second currency;
obtaining a quote of a rate of exchange for selling said second currency and buying said first currency;
determining a net amount of currency exchange transactions to buy or sell said first currency and to sell or buy said second currency; and
executing said net currency exchange transactions by having said central currency exchange management entity to conduct said net currency exchanges with an outside entity to limit the exposures of currency transactions for said first and second entities.

6. A method as described in claim 2 wherein said spread between a bid ask quotation is credited to an account of said central currency exchange management entity on an amount of currency exchange transactions equal to the amount of currency exchange requirements for said entities minus the net amount of currency exchange transactions of said entities.

7. A method of conducting exchanges of currency for a plurality of entities as described in claim 5 wherein said central currency exchange management entity is credited with a spread of the bid and ask quote of the rate of exchange of a net amount of currency exchange transactions to buy or sell said first currency and to sell or buy said second currency minus the currency exchange requirements of said first and second entities.
